(19) United States
(12) Patent Application Publication
(10) Pub. No.: US 2022/0379637 A1
(43) Pub. Date: Dec. 1, 2022

(54) CUTTING OR SCORING A SUBSTRATE

(71) Applicant: HEWLETT-PACKARD DEVELOPMENT COMPANY, L.P., Spring, TX (US)

(72) Inventors: Raimon CASTELLS DE MONET, Sant Cugat del Valles (ES); Alberto BORREGO LEBRATO, Sant Cugat del Valles (ES); Eduard BARBA GOMEZ-ALVAREZ, Sant Cugat del Valles (ES)

(21) Appl. No.: 17/775,107

(22) PCT Filed: Jan. 29, 2020
(86) PCT No.: PCT/US2020/015541

§ 371 Date: May 6, 2022

(51) Int. Cl. B41J 11/66; B26F 3/06; B29C 35/08

(52) U.S. Cl. CPC B41J 11/663; B26F 3/06; B29C 35/0805; B29C 2035/0822

(57) ABSTRACT

A method of cutting or scoring a substrate comprises: providing a substrate which has a maximum of radiation absorption at a first wavelength band; depositing on the substrate, in a predetermined pattern, a heating fluid which has a maximum of radiation absorption at a second wavelength band; and exposing a surface region of the substrate to electromagnetic radiation at the second wavelength band, the surface region including the predetermined pattern, to cut or mark the substrate along the predetermined pattern. The first wavelength band differs from the second wavelength band.

### BACKGROUND

Substrates carrying printed images may be post-processed by cutting, scoring, perforating, marking or the like. Post-processing may become a bottleneck in a substrate printing and processing workflow if performed in a separate station. Cutters integrated in a printing device may comprise complex mechanisms that create additional investment for mounting and servicing.

### BRIEF DESCRIPTION OF THE DRAWINGS

For the purpose of illustration, certain examples will now be described with reference to the accompanying drawings, in which:

FIG. 1 shows a flow diagram illustrating a method according to an example;

FIG. 2 shows a schematic illustration of a device according to an example in a top view;

FIG. 3 shows a schematic illustration of a radiation part of a device according to an example in a side view;

FIG. 4 shows a schematic illustration of a product according to an example in a top view;

FIG. 5A shows a schematic diagram illustrating emitted power over wavelength at different radiation patterns of various examples; and

FIG. 5B shows a schematic diagram illustrating absorption over wavelength of different absorbers of various examples.

### DETAILED DESCRIPTION

In the following detailed description, reference is made to the accompanying drawings. The examples in the description and drawings should be considered illustrative and are not to be considered as limiting to the specific example or element described. Multiple examples may be derived from the following description and/or drawings through modification, combination or variation of certain elements. Furthermore, it may be understood that also examples or elements that are not literally disclosed may be derived from the description and drawings by a person skilled in the art. Whereas different examples are described herein, it is understood that features of these examples may be used individually or in combination thereof to derive further variations beyond those explicitly describes herein.

A method and a device for processing a substrate and a product including a processed substrate are disclosed herein. Processing is provided in the form of cutting, scoring, perforating, marking, eroding or the like, of the substrate relative to an image printed on the substrate. The substrate may be a textile, in particular a textile including synthetic fibers, a sheet material, including those from paper, wood, cardboard and plastic or a foil. Some examples of substrate materials include polyester, polyimide, and polyurethane, such as a polyester based substrate. Examples of textiles are woven, non-woven, or knitted materials. In various examples, the textiles may include synthetic fibers or a mixture of natural and synthetic fibers, such as polyester, polyamide, polyacrylate and elastane, viscose, modal, and acetate, which may be mixed with wool, cotton, linen, hemp, sisal, jute and the like.

Further, in the present disclosure, for ease of illustrating various examples, reference to cutting is meant to also include any similar form of processing where a substrate is cut or partially cut, such as by perforating, scoring, marking or eroding a substrate surface so as to physically cut through or remove at least part of the substrate in a direction of the substrate thickness.

The substrate may be cut by burning the substrate along a line printed on the substrate. This may be achieved by applying a heating fluid to the substrate, the heating fluid having an absorption spectrum differing from an absorption spectrum of the substrate. Then, the substrate may be exposed to electromagnetic radiation, such as ultraviolet (UV) or infrared (IR) radiation, having a radiation spectrum in a wavelength band matching the absorption spectrum of the heating fluid. The radiation spectrum and the absorption spectrum of the heating fluid may match to such an extent that radiation heats the printed heating fluid to burn the substrate along a printed line or other printed pattern, partially or all the way through the substrate thickness. The substrate hence is cut, scored, perforated or eroded in the area where the heating fluid has been printed. This may in particular be along a line printed with the heating fluid and aligned with a printed image, e.g. extending around a periphery of the printed image, to perform a contour cut, for example.

Heat is created locally where the heating fluid has been applied by interaction between the heating fluid and the radiation. The remainder of the substrate, where no heating fluid is deposited, may remain unaffected. The area of the substrate having no heating fluid printed thereon may have an absorption spectrum different from that of the heating fluid so that the substrate will not be heated in the area free of the heating fluid, even if irradiated in that area. Further, also any other substances deposited on the substrate, such as a substrate base coloring or an image printed on the substrate by inkjet printing, for example, may have an absorption spectrum different from that of the heating fluid so that the substrate will not be heated in the area treated by said other substances, even if irradiated in that area.

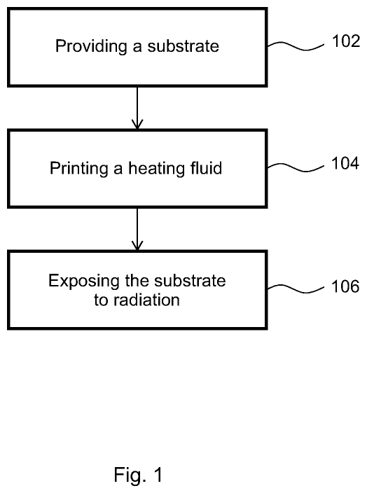

FIG. 1 shows a flow diagram illustrating a method according to an example. The method includes: at 102, providing a substrate which has a maximum of radiation absorption at a first wavelength band; at 104, depositing on the substrate, in a predetermined pattern, a heating fluid which has a maximum of radiation absorption at a second wavelength band; and, at 106, exposing a surface region of the substrate to electromagnetic radiation at the second wavelength band, the surface region including the predetermined pattern, to cut or mark the substrate along the predetermined pattern. The first wavelength band differs from the second wavelength band.

For example, the second wavelength band may be a near infrared, NIR, band, a medium infrared, MIR, band, a far IF, FIR, band or an ultraviolet, UV, band, such as the UV-A, UV-B or UV-C band.

In one example, the electromagnetic radiation has more than 80% of its power in the second wavelength band and less than 20% of its power in the first wavelength band. In the same or another example, an absorption of a part of the substrate S free from heating fluid is lower than 40% in the second wavelength band and higher than 40% in the first wavelength band. In the same or yet another example, an absorption of a part of the substrate S treated with the heating fluid is higher than 40% in the second wavelength band and lower than 40% in the first wavelength band.

The surface region of the substrate exposed to the electromagnetic radiation my extend across the entire width and/or length of the substrate surface, or it may extend across a portion of the substrate surface which is wider than the predetermined pattern. The second wavelength band may be adapted to the absorption wavelength of the heating fluid and may be a near infrared, NIR, band, a medium infrared, MIR, band or an ultraviolet, UV, band, for example. Accordingly, the heating fluid printed in a predetermined pattern and the electromagnetic radiation, directed at an area which includes the predetermined pattern, interact to generate localized heat which may be sufficient to cut, score, perforate or erode the substrate along the predetermined pattern without specifically focusing the radiation onto the predetermined pattern. For example, the heating fluid may be printed along a narrow line, e.g. a line having a width of less than a millimeter, such as 0.2-1.0 mm, and the irradiated area may be as wide as the entire substrate and in any case much wider than the predetermined pattern, e.g. at least ten times wider than the printed line.

The method may further include depositing an image forming fluid on the substrate during a same printing pass in which the heating fluid is also deposited. The predetermined pattern in which the heating fluid is deposited may extend along a line that is aligned to an image formed by depositing the image forming fluid. For example, the printed pattern may include a printed line circumscribing a printed image or may include a raster of vertical and/or horizontal lines along X and Y directions, as illustrated below. Accordingly, the predetermined pattern may be arranged so as to cut one or a plurality of printed images from a substrate.

The image forming fluid may have a third maximum of radiation absorption at a third wavelength band, wherein the third wavelength band differs from the second wavelength band and may differ from or be the same as the first wavelength band. The image forming fluid may, for example, be a dye sublimation fluid, such a dye sublimation ink, to transfer the ink to the substrate using heat. In dye-sublimation printing, a dye sublimation ink, for example, is inkjet printed directly onto a substrate to form an ink layer on the substrate. The substrate having the ink layer disposed thereon may then be processed in a sublimation zone where the sublimation ink layer is exposed to electromagnetic radiation. In an example, the exposing to electromagnetic radiation provides discrete, localized heating from the active agent to accomplish sublimation of the dye sublimation ink into the substrate, to form a printed image. The sublimation of the dye, causing it to penetrate into the substrate, forms the image on the substrate. In other examples, the use of the heating fluid for cutting or scoring the substrate is combined with other printing technologies and inks which can dry without the application of heat, such as by evaporation.

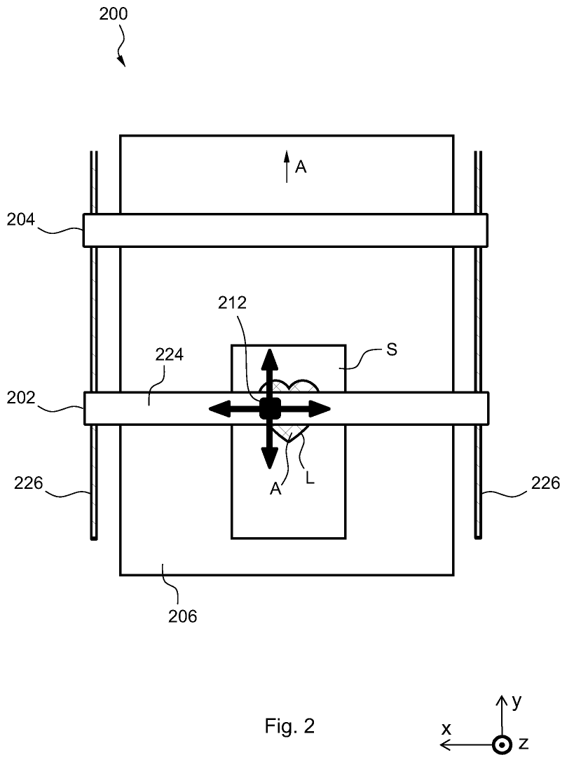

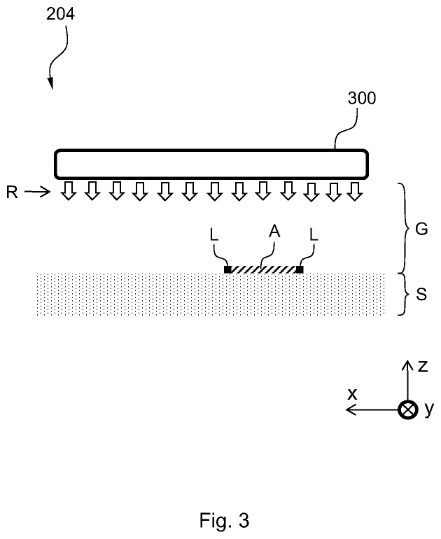

FIG. 2 shows a schematic illustration of a device 200 according to an example, in a top view thereof. The device 200 may be configured in a way similar to a dye sublimation printer or another type of inkjet printer, including large format printers, continuous-web printers and flat-bed printers. The device 200 may include a printing part 202 and a radiation part 204 arranged above a support platen 206. The radiation part 204 of the device 200 according to an example is separately shown in FIG. 3, in a side view. Reference is made to FIG. 3 where applicable. The printing part 202 and the radiation part 204 as shown in FIG. 2 may be part of a single-stage or a two-stage device 200.

In the examples of FIG. 2 and FIG. 3, the printing part 202 may include a first printhead to print, on a substrate S, an image forming ink having a first radiation absorption pattern over a wavelength and a second printhead to print, on the substrate S, a heating fluid having a second radiation absorption pattern over a wavelength, wherein the first radiation absorption pattern is different from the second radiation absorption pattern. The printheads may be selected, for example, from a piezo-inkjet printhead or thermal-inkjet printhead. Further, the radiation part 204 may be to expose at least a portion of the substrate to electromagnetic radiation having a wavelength band matching with a maximum of the second radiation absorption pattern to cut or mark the substrate along a pattern printed by the second printhead, wherein the radiation part is designed to expose a portion of the substrate that is wider than any shape to be printed by the second printhead and/or an image to be printed by the first printhead.

If the first printhead is a dye sublimation inkjet printhead, the radiation part 204 can be used for both heating the dye sublimation ink and the heating ink and may have an adjustable radiation wavelength to adapt the electromagnetic radiation to the absorption wavelength bands of the dye sublimation ink and the heating fluid, respectively. In another example, the dye sublimation ink and the heating fluid may have the same or similar absorption wavelength but different absorption rate. For example, the radiation absorption of the dye sublimation ink is at the same wavelength of wavelength range as the heating fluid but is considerably lower than that of the heating fluid. In another example, the first printhead may be an inkjet printhead to dispense another type of ink, such as a latex ink or a solvent-based ink. In this case, the printed image may not be irradiated.

The radiation part 204 may include at least one of an infrared, IR, emitter and an ultraviolet, UV, emitter which may extend or be movable across a width of the substrate S or across a width of the support platen 206. The IR emitter may include a medium IR, MIR, emitter and a near IR, NIR, emitter or a far IF, FIR, emitter. The wavelength of the radiation part 204 may be adjustable. The radiation part 204 may be designed to simultaneously emit electromagnetic radiation across part of or the entire width of the support platen 206.

FIG. 2 schematically shows a printhead carriage 212 wherein the first printhead and the second printhead both are arranged on the printhead carriage 212 and are controlled to deposit the image forming ink and the heating fluid during a same pass of the printhead carriage in a printhead scanning direction X.

Whereas, the radiation part 204 may be arranged on the printhead carriage 212, in the example of FIG. 2, the radiation part 204 is arranged at a separate radiation zone which is downstream of a print zone in a processing direction, or Y direction. In the example of FIG. 2, a print zone is below the printing part 202 and a radiation zone is below the radiation part 204, in the vertical or Z direction.

The device 200 can be used to print both an image forming ink and a heating fluid on a substrate S and to expose the heating fluid and, as needed, the image forming ink to electromagnetic radiation, as described above with reference to FIG. 1. The substrate S may be a textile, in particular a textile including synthetic fibers, a sheet material, including those from paper, wood, cardboard, glass and plastic, or a foil of similar materials. Some examples of substrate materials include polyester, polyimide, and polyurethane. Examples of textiles are woven, non-woven, or knitted materials. In various examples, the textiles may include synthetic fibers or a mixture of natural and synthetic fibers, such as polyester, polyamide, polyacrylate and elastane, viscose, modal, and acetate, which may be mixed with wool, cotton, linen, hemp, sisal, jute and the like.

In the specific example of FIG. 2, one or more printheads may be located in the carriage 212, which may be designed as a printer carriage or similar to a printer carriage. The substrate S may be placed on the support platen 206 below the printhead carriage 212. The support platen 206 has a width in the X direction and a length in the Y direction, as shown in FIG. 2, with Z designating the vertical direction. In one example, dimensions of the support platen 206 may be such that at least a substrate S of a size of a regular DIN A4, DIN A3, DIN A2 or DIN A1 sheet may be received. For example, at least one of the width and the length of the support platen 206 may be between 0.2 meters and 5 meters or between 0.2 meters and 2 meters. The support platen 206 may be substantially plane to receive and support the substrate S. In other configurations, the substrate may be supported by one or more support rollers. The substrate S is provided on the support platen 206 so as to present a substantially plane substrate surface to the printheads located in the printhead carriage 212.

In the example of FIG. 2, the printing part 202 may be to deposit a heating fluid on the substrate S along a line L surrounding a printed image which is shown as a predetermined area A. The predetermined area A is shown as a heart shape in FIG. 2. The printing part 202 may have a configuration of or be similar to a drop-on-demand printer, including an inkjet-type printhead, such as a thermal inkjet or piezo-electric printhead, for example. The printing part 202 may comprise a 2-axis carriage. The 2-axis carriage comprises a carriage part 212 for holding one or more printheads, an X-axis guide bar 224 and two Y-axis guide bars 226. The 2-axis carriage 212 is to move the printheads in two dimensions parallel to and above the substrate S and/or the support platen 206.

The X-axis guide bar 224 is to guide and move the carriage 212 including the printheads along the width direction X of the support platen 206. Further, the two Y-axis guide bars 226 are to support the X-axis guide bar 224 and are to guide and move the carriage 212 along the length direction Y of the support platen 206. Further, the 2-axis carriage may comprise a drive unit and a control unit to carry out and control the movement of the carriage. Thus, the printheads may be arranged moveably in the X and Y directions over the support platen 206 by positioning the carriage. The carriage 212 may be arranged at a fixed Z position over the receiving surface. Thus, the printheads may move in a plane parallel to the substrate S.

In one example, the carriage 212 may be to scan along the width direction X of the support platen 206 by means of the X-axis guide bar 24 across a strip portion of the substrate S between left- and right-hand boundaries (as shown in FIG. 2) of the predetermined area A. A strip portion may be defined as a row or swath printed along the width direction X of the support platen 206. During scanning, the first printhead may eject an image forming ink across a predetermined area A to form an image therein, and the second printhead may eject a heating fluid along the peripheral line L around the predetermined area, as described further below.

After scanning one strip portion and printing one swath of the image forming ink and the heating fluid, the carriage 212 may be moved along the length direction Y in order to arrange the carriage 212 for printing a next strip portion between left and right-hand boundaries of the predetermined area A. The next strip portion may be immediately adjacent to or overlapping with the preceding strip portion. The offset between two subsequent strip portions may be in the range of 0.5 cm to 10 cm, e.g. in the order of about 0.5 cm, 1 cm or 2 cm, depending on the length of a nozzle array of the printhead included in the carriage 212, for example. The scanning speed may be in the order of 50-200 cm/s, for example. This procedure may be repeated until the predetermined area A has been fully scanned by the carriage 212, with a number of swaths of image forming ink and heating fluid printed adjacent to each other or in an overlapping print mode. The heating fluid, like the image forming ink, thus is printed in rows or swaths along the width direction X, in this example to define a peripheral line L around the predetermined area A. Printing in the X direction may be performed both from left to right and from right to left (as seen in FIG. 2).

The printing of one strip portion may be performed in continuous swaths. During continuous printing, the printheads included in the carriage 212 may continuously eject the image forming fluid and the heating fluid and scan across the substrate S to deposit the image forming ink within the predetermined area A and the heating fluid on the peripheral line L.

In another example, a page wide print bar may be provided, having a nozzle array spanning the width of the support platen 206, also designated as page wide array, or a sub-portion thereof. The page wide printhead (not shown) can be provided on a Y-axis carriage for movement in the Y direction, for example, wherein the Y-axis carriage could be supported by the two Y-axis guide bars 226 as shown in FIG. 2. Printing a swath of image forming ink in the X direction could be performed by sequentially or simultaneously printing the image forming ink by the page-wide nozzle array between left- and right-boundaries of the predetermined area A of the substrate S. At the same time, the heating fluid can be printed along the peripheral line L by providing a respective heating fluid nozzle array. Printing subsequent swaths in the Y direction can be performed by moving the Y-axis carriage in the Y direction.

In a further example, the device 200 may comprise a feed mechanism to feed the substrate S in the form of a sheet or continuous web through a printing zone, e.g. in the lengthwise direction Y, with the first and second printheads located above the printing zone. The first and second printheads may comprise a page wide nozzle array or may be located in a carriage supported by the X- axis guide bar 224 for scanning the printeheads in the X direction.

The heating fluid may be compatible with available printing technology, such as digital inkjet printing technology. In this case, a standard printhead can be used to eject the heating fluid and print the heating fluid along the line L, following digital or analog printing methodology in the same way as an image is printed.

In different examples, the heating fluid may be an ink including an electromagnetic radiation-absorbing active material and an aqueous or non-aqueous vehicle. The electromagnetic radiation-absorbing active material may be an IR light absorber, a near-infrared (NIR) light absorber, a plasmonic resonance absorber, a UV light absorber and combinations thereof. These electromagnetic radiation-absorbing active materials may be provided in the form of or may include a dye or pigments. In one example, the heating fluid includes pigmented carbon black ink and a transparent Tint Fluid agent to promote absorption in the IR band. In another example, the heating fluid may include an additive to absorb energy at the radiation wavelength ranging from about 360 nm to about 410 nm to promote absorption in the UV band. The heating fluid may be based on commercially available inkjet inks.

In one example, an IR light absorber includes a dispersion comprising a metal oxide nanoparticle having the formula MmM′On wherein M is an alkali metal, m is greater than o and less than 1, M′ is any metal, and n is greater than o and less than or equal to 4; a zwitterionic stabilizer; and a balance of water. The metal oxide nanoparticles may be present in the dispersion in an amount ranging from about 1 wt % to about 20 wt % based on the total weight of the dispersion. In some other example, the zwitterionic stabilizer may be present in the dispersion in an amount ranging from about 2 wt % to about 35 wt % (based on the total weight of the dispersion). In yet some other examples, the weight ratio of the metal oxide nanoparticles to the zwitterionic stabilizer ranges from 1:10 to 10:1. In another example, the weight ratio of the metal oxide nanoparticles to the zwitterionic stabilizer is 1:1. For example, M can be an alkali metal like lithium (Li), sodium (Na), potassium (K), rubidium (Rb), cesium (Cs), or mixtures thereof.

In one example, NIR absorbing dyes or pigments may include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dypyromethene dyes or pigments, or aza-boron-dipyrromethene dyes or pigments.

In one example, a plasmonic resonance absorber may comprise an inorganic pigment. The inorganic pigment may comprise lanthanum hexaboride (LaB₆), tungsten bronzes (AₓWO₃), indium tin oxide (In2O₃:SnO₂, ITO), antimony tin oxide (Sb₂O₃:SnO₂, ATO), titanium nitride (TiN), aluminum zinc oxide (AZO), ruthenium oxide (RuO₂), silver (Ag), gold (Au), platinum (Pt), iron pyroxenes (AₓFe_{y}Si₂O₆), modified iron phosphates (AₓFe_{y}PO₄), modified copper phosphates (AₓCu_{y}PO_{z}), modified copper pyrophosphates (AₓCu_{y}P₂O₇), and combinations thereof.

In one example, a UV light absorber may be an inkjet fluid having an additive to absorb energy at the radiation wavelength ranging from about 360 nm to about 410 nm. The additive may be selected from the group consisting of a compound containing from 3 to 5 fused benzene rings and a coumarin derivative. The ink further may include a co-solvent and water, for example.

In the example of FIGS. 2 and 3, the radiation part 204 of the device 200 may be arranged to expose the substrate S to electromagnetic radiation R, in particular the pattern, such as the line L, printed with the heating fluid. In particular, the radiation part 204 is to illuminate the substrate S after the line L has been printed with the heating fluid. The radiation part 204 may include a radiation source 300, such as a lamp, which is stationary above the support platen 206 or which can be moved in the Y direction or in the X and Y directions, similar to the movement of the carriage 212, to arrange the radiation source 300 above the printed line L.

The radiation source 300 may comprise a single emitter such as an LED, for example, or it may comprise an array of emitters, such as LEDs or other light sources. The LED may be an UV-LED or an IR-LED, for example. The radiation source 300 is provided at a distance G from the substrate S. The radiation source 300 may be designed to emit light in a predefined or preset wavelength band, for example the UV band, including the UV-A, UV-B, UV-C bands, or the IR band, including the MIR or NIR bands. The radiation source 300 further may be designed to adjust the wavelength band of the emitted light to match the emitted light spectrum to the absorption pattern of different heating fluids and, as needed, dye sublimation inks. In other examples, the use of the heating fluid for cutting or scoring the substrate is combined with other printing technologies and inks. The arrows R below the radiation source 300 illustrate a direction of the electromagnetic radiation for exposing the substrate S.

For example, when using a heating fluid having an IR light absorber, the wavelength of the radiation source 300 can be adjusted to be in the range of 780 nm to 1 mm. When using a heating fluid having an NIR light absorber, the wavelength of the radiation source 300 can be adjusted to be in the range of 780 nm to 3 μm. When using a heating fluid having an MIR light absorber, the wavelength of the radiation source 300 can be adjusted to be in the range of 3 to 50 μm. When using a heating fluid having a plasmonic resonance absorber, the wavelength of the radiation source 300 can be adjusted to be in the range of 200 nm to 410 nm. When using a heating fluid having a UV light absorber, in particular UV-A, UV-B and UV-C, the wavelength of the radiation source 300 can be adjusted to be in the range of 315 nm to 410 nm, 280 nm to 315 nm and 200 nm to 280 nm, respectively.

The radiation source 300, in general, emits light at a spectral band aligned with a maximum absorption band of the heating fluid. Exposure time and radiation energy are selected so as to sufficiently heat the heating fluid drops printed along the line L to burn the substrate S along the line L so that the substrate is cut or scored along said line L. The cutting depth may depend on the exposure time, radiation energy and distance between the radiation source 300 and the substrate S. Further, by controlling the amount of heating fluid deposited on the substrate, i.e. by adjusting the fluid density, the heat energy to burn the substrate can be tuned so that different features, like cut lines, holes and textures, can be created based on different heat intensities.

The substrate hence is cut, scored, perforated or eroded along the line L where the heating fluid has been printed. This is achieved without focusing the electromagnetic radiation on the cutting line. As mentioned above, reference to cutting is meant to also include any similar form of processing where a substrate is cut or partially cut, such as by perforating, scoring, marking or eroding a substrate surface so as to physically cut through or modify at least part of the substrate in a direction of the substrate thickness

The heating fluid and the radiation band are selected such that radiation does not impact those portions of the substrate S where an image has been printed, such as in area A, or where no ink or other fluid has been deposited. For example, the absorption band of the substrate S and any dyes used for pre-coloring the substrate S or image forming inks printed on the substrate may be lower than or outside of the radiation band of the radiation source 300 for exposing the heating fluid.

In one example, the heating fluid can be a Latex ink having an NIR absorption spectrum and the image forming ink can be a dye sublimation ink having an MIR absorption spectrum or another type of ink, e.g. one which dries by evaporation. The image forming ink and the heating fluid can be printed simultaneously in the same passes or consecutively in different passes, using first and second printheads supported by the carriage 212. The printed image and the printed line L of heating fluid can be irradiated by the same radiation source 300, if the radiation source is adjustable to the respective wavelength band, or can be irradiated by different dedicated radiation sources.

In one example, an exposure time may be in the range from about 0.1 seconds to about 20 seconds, or from about 0.1 seconds to about 5 seconds. To achieve a desired amount of heating along the printed line L, power settings of the radiation source 300 may be adapted. A power setting may range from about 5 W/cm² to about 25 W/cm², or from about 8 W/cm² to about 20 W/cm². The power setting may depend on the type of substrate, type of radiation source 300, the heating fluid and/or the distance G. In consequence, an energy exposure may range from about 0.5 J/cm² to about 20 J/cm², for example. The distance G between the radiation source 300 and the substrate S may be in the range of about 3 to 20 mm or from about 4 to 15 mm. The smaller the gap G the less irradiation power is necessary. Moreover, by controlling the amount of heating fluid deposited on the substrate, i.e. by adjusting the heating fluid density, the heat energy to burn the substrate can be tuned so that different features, like cut lines, holes and textures, can be created based on different heat intensities.

In one example, the substrate S has a radiation absorption pattern. Further, the heating fluid has another different radiation absorption pattern. For example, the radiation absorption pattern of the substrate S and the radiation absorption pattern of the heating fluid may have maxima in respectively different wavelength bands. In one example, the radiation absorption pattern of the substrate S has a minimum in a wavelength band where the radiation absorption pattern of the heating fluid has a maximum. Similarly, the radiation absorption pattern of the substrate S may have a maximum in a wavelength band where the radiation absorption pattern of the heating fluid has a minimum. When depositing the heating fluid on the substrate S, the radiation absorption pattern of the part of the substrate S treated with the heating fluid will be modified and may become the same as or close to the radiation absorption pattern of the heating fluid.

Accordingly, the radiation source 300 can be selected such that an emission power pattern of the radiation source matches with the radiation absorption pattern of the heating fluid. For example, the radiation source 300 can be further selected such that its emission power pattern does not match with the radiation absorption pattern of the substrate S itself. Consequently, the radiation source 300 may be to expose the substrate S to electromagnetic radiation having a wavelength band which matches with a maximum of the radiation absorption pattern of the heating fluid to cut the substrate S along the line L. The cutting line L may be printed to surround a printed image and/or may be printed to define edges of substrate sub-portions to be separated from each other. For example, a numb of cutting lines may be arranged to divide the substrate into a number of rectangles.

The device 200 as described with respect to FIGS. 2 and 3 may be a printer having an integrated cutting device wherein printheads for dispensing image forming ink and heating fluid are carried by a common carriage 212. In another example, the device 200 may be part of a processing line wherein it may be located downstream of a printer to cut a substrate on which an image has been printed by the printer. In still another example, the device 200 can be a stand-alone cutting device, not including an image forming printhead.

In the example of FIG. 2, the device may have a configuration similar to a flat-bed printer where the substrate remains stationary on the support platen. In another example, a transport mechanism ca be provided to transport the substrate through a print zone and a radiation zone in an advance direction as shown by arrow A. If the device 200 is integrated into a printer, a printer carriage and carriage drive mechanism can be used to support and scan a printhead to eject heating fluid. The radiation source 300 can also be supported by the printer carriage or can be installed at a position in the printer downstream of the carriage over the support platen 206. The substrate S to be processed can be located on the support platen 206. If the substrate S is a continuous material web, a printer feed mechanism can be used to transport the substrate across the support platen. In another example, the device may be separate from a printer but may have support and carriage mechanisms similar to a printer.

In FIG. 2, the radiation part 204 and the printing part 202 of the device 200 are shown as separate units by way of example. Nevertheless, the radiation part 204 and the printing part 202 may be integrated in a single unit. In different examples, the radiation source 300 may be static or movably arranged in X and/or Y direction over the support platen 206 so as to scan across the radiation zone in X- and/or Y-direction over the support platen 206.

In one example, the radiation source 300 may comprise a page wide lamp or a page wide array of lamps. The page wide lamp or the page wide array of lamps may be to simultaneously or successively emit light at the substrate S.

A radiation power of the radiation source 300 may be set depending on a distance G between substrate S and the radiation source 300 and/or a size of the substrate area to be exposed to radiation. The radiation power may range from about 8 W/cm² to about 20 W/cm². Further, an exposure time may be set from about 1 seconds to about 20 seconds, for example.

An exposure time may be set by controlling the irradiated area and/or speed of the feeding mechanism for the sheet or the continuous web in lengthwise direction Y through the radiation zone. The speed may be set such that the time for running the substrate S through the radiation zone ranges from about 1 seconds to 20 seconds. In another example, the sheet or the continuous web may be stationary and the radiation source 300 of the radiation part 204 may be to scan across the substrate S for an exposure time of about 1 seconds to 20 seconds.

In the example where the radiation part 204 is implemented with the printing part 202 in a single unit, the printing zone and radiation zone may overlap or coincide. In one example, the carriage 212 for supporting the printheads may also support the radiation source 300. In another example, the radiation part 204 may be statically arranged in the device. The radiation part 204 may be to radiate light during printing of the heating fluid. Further, the radiation part 204 may be arranged downstream of the printing part 202 in the same unit. Thus, the radiation part 204 can follow a scanning movement of the printing part 202, thereby illuminating parts of the substrate S on which the heating fluid has been printed.

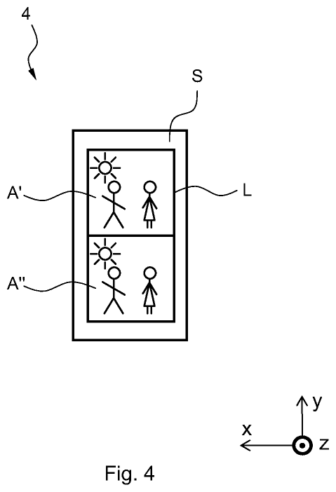

FIG. 4 shows a schematic illustration of a product 400 according to an example in a top view. The product 400 includes a substrate S and two images printed on the substrate S in two regions A′ and A″. Lines L of printing fluid have been printed around the peripheries of the image regions A′ and A″ and the lines L have been irradiated with electromagnetic radiation having a wavelength band matching the absorbance wavelength band of the heating fluid. Accordingly, the substrate is heated along those lines L in such a way that the substrate material melts and is cut along the lines so that the individual image are separated from one another, leaving two separate images A′ and A″ and a surrounding margin of the substrate S (although not shown separately in the schematic drawing of FIG. 4). The cutting lines can be distinguished from those produced by knife cutters on the basis of molten substrate edges. In particular, when cutting the fabric substrate, edges cut with a knife may show some lint while this does not occur in described method.

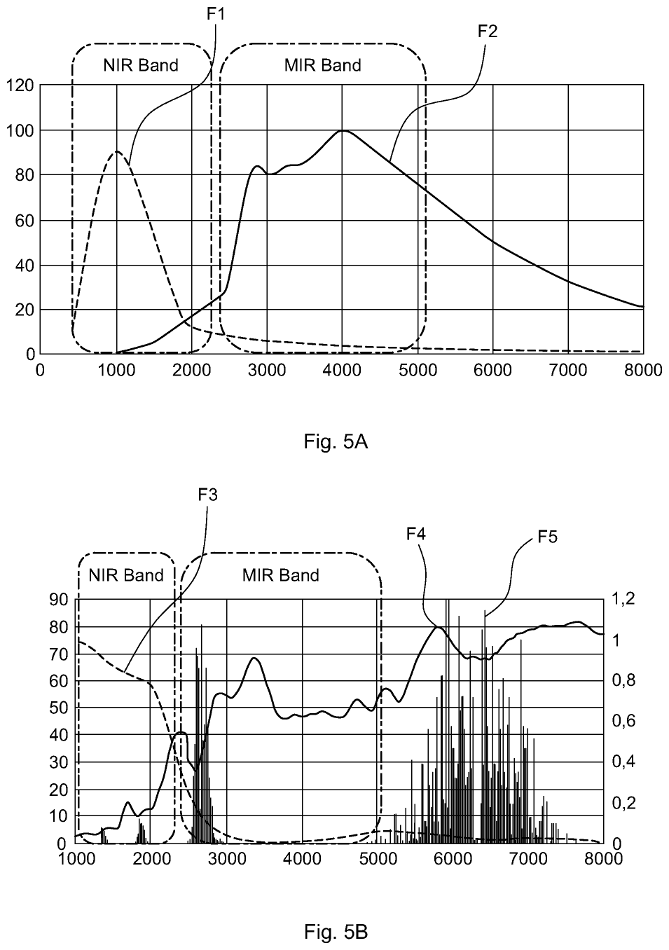

FIG. 5A shows a schematic diagram illustrating emitted power over wavelength of different radiation sources 300. Reference is made to FIGS. 1 to 4, where applicable. In particular, FIG. 5A shows two different graphs F1 and F2 respectively representing emitted power over wavelength for different lamps used as radiation source 300. On the axis of ordinates, an electrical power is shown in percent (%) of a maximum power. On the axis of abscissa, a wavelength is shown in nm.

In the example of FIG. 5A, the graph F1 represents the emitted power over wavelength of a halogen IR lamp. The graph F1 shows that the radiated power of the halogen IR lamp has a maximum in the NIR band, i.e. at about 1200 nm. In particular, more than 90% of the power radiated by the halogen IR lamp may be radiated within the NIR band. The rest of the power may be radiated in neighboring bands, for example in bands having larger wavelengths and lower frequencies. In this example, the maximum power is at about 90 kW.

In the example of FIG. 5A, the graph F2 represents the emitted power over wavelength of a ceramic IR lamp. The graph F2 shows that the radiated power of the ceramic IR lamp has a maximum in the MIR band and outside the NIR band. In particular, more than 90% of the power radiated by the ceramic IR lamp may be radiated outside the NIR band, for example in bands having larger wavelengths—lower frequencies. About 70% of the power radiated by the ceramic IR lamp may be radiated in the MIR band. Less than 10% of the power may be radiated in the NIR band.

FIG. 5B shows a schematic diagram illustrating absorption over wavelength of different absorbers which may be used in a heating fluid and a dye sublimation ink. On the axis of ordinates, absorption is shown in percent (%). On the axis of abscissa, a wavelength is shown in nm. Reference is made to FIGS. 1 to 4, where applicable. In particular, FIG. 5B shows two different graphs F3 and F4 respectively representing absorption of power over wavelength for the substrate treated with the heating fluid and the untreated substrate S. Additionally, FIG. 5B shows the absorption of power over wavelength for a dye sublimation ink deposited on the substrate, in the form of a bar diagram F5. Maxima of power absorption of the dye sublimation ink may be different from or overlap with those of an untreated substrate. Moreover, different ink colors may have different spectra in the visible band but no significant differences outside the visible band.

In the example of FIG. 5B, the graph F3 represents the absorption over wavelength of a substrate S treated with an electromagnetic radiation-absorbing active material in a heating fluid to shift the absorption of the substrate S towards the NIR band. In particular, the electromagnetic radiation-absorbing active material may be an NIR light absorber in the form of or may include a dye or pigments. For example, the NIR light absorber may include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dypyromethene dyes or pigments, or aza-boron-dipyrromethene dyes or pigments.

In the example of FIG. 5B, the heating fluid may be pigmented carbon black ink or low tint fluid agent which is transparent. The graph F3 shows that the absorption of the substrate treated with carbon black ink has a maximum in the NIR band and a minimum in neighboring bands of the NIR band, for example in bands having larger wavelengths and lower frequencies. For example, the absorption in the NIR band may be higher than 35%, wherein an absorption in neighboring bands may be lower than 35%.

Generally, the heating fluid may be selected to match a wavelength radiation pattern of a radiation source 300 shown in FIG. 5A as graph F1. Alternatively, the radiation source 300 shown in FIG. 5A as graph F1 may be selected or adjusted to match a radiation absorption pattern over wavelength of the heating fluid shown in FIG. 5B as graph F3.

In the example of FIG. 5B, the graph F4 represents the absorption over wavelength of the substrate S free of any heating fluid and free of image forming ink. The graph F4 shows that the absorption of the substrate S has a maximum outside the NIR band. In particular, an absorption of the substrate S in the NIR band may be lower than about 35%.

Substrate portions free of any heating fluid may have a radiation absorption which may increase with wavelength, as shown in the graph F4 of FIG. 5B. Correspondingly, the heating fluid may be selected so that the radiation absorption of the heating fluid may substantially decrease with wavelength. Thus, the heating fluid may be selected so as to have a radiation absorption with a maximum in an NIR band or other defined wavelength bands, such as the UV band, depending on the radiation source to be used.

As shown in FIG. 5B, a dye sublimation ink deposited on the substrate may have a radiation absorption maximum within the MIR band, and an MIR band emitter, such as a ceramic lamp can be used to irradiate any portions of the substrate printed with the dye sublimation ink to create the image, as described above. Ceramic lamps contribute in the MIR and FIR bands to dry, sublimate and fix dye sublimation ink.

Experiments have shown that the method and device described herein can precisely cut a substrate, in particular a synthetic substrate or a substrate including a synthetic material, along a printed line without focusing the electromagnetic radiation on the line. The cutting line can simply be defined by printing using inkjet printing technology, for example. In a dye sublimation printer, having an integrated radiation source, the cutting feature can be implemented by adding a printhead for dispensing the heating fluid and by adjusting the radiation source to the absorption wavelength pattern of the heating fluid, without any further hardware components. The heating fluid and its radiation wavelength can be selected such that the bulk of the substrate is not affected by the electromagnetic radiation. The method and device can be selective in that portions of the substrate not to be treated by heating fluid and dye sublimation ink remain unaffected. Further, the method also is compatible with irregular substrate surfaces.

The extra time for cutting is relatively low, such as less than a minute or even only a few seconds as the heating fluid can be deposited simultaneously with printing an image and the extra time for irradiation is in the order of seconds, depending on the size of the area spanned by the printed pattern. Cutting consumes little energy and only little resources, such as a limited amount of heating fluid. Costs and complexity are low.

If the device 200 is a printer having an integrated cutting device, the cutting method can be performed with perfect registration to the printed image. Both the image and the cutting line can be printed in the same passes, with no re-registration of the substrate. Even if a substrate undergoes some change in the morphology, such as shrinkage or other deformation during printing, as may happen with printed textiles, the cutting lines will still be registered to any printed image, as they may be generated in the same printing process. In some examples, the contour to be cut or region to be scored, marked or perforated or the like, can be digitally printed in the same way and at the same time as an image is being printed. In some examples, there is no operator handling between printing and cutting.

Further, the device 200 can be integrated in a printer and make use of printer equipment, such as a substrate holding mechanism, substrate feed mechanism, printing mechanism and a carriage mechanism. The heating fluid may be handled like ink.

The statements set forth herein under use of hardware circuits, software or a combination thereof may be implemented. The software means can be related to programmed microprocessors or a general computer, an ASIC (Application Specific Integrated Circuit) and/or DSPs (Digital Signal Processors). Whereas some details have been described in terms of a computer-implemented method, these details may also be implemented or realized in a suitable device, a computer processor or a memory connected to a processor, wherein the memory can be provided with one or more programs that perform the method, when executed by the processor.

1. A method, the method comprising:
providing a substrate which has a maximum of radiation absorption at a first wavelength band;
depositing on the substrate, in a predetermined pattern, a heating fluid which has a maximum of radiation absorption at a second wavelength band; and
exposing a surface region of the substrate to electromagnetic radiation at the second wavelength band, the surface region including the predetermined pattern, to cut or mark the substrate along the predetermined pattern;
wherein the first wavelength band differs from the second wavelength band.

2. The method according to claim 1, wherein the exposed surface region of the substrate extends across the entire substrate surface.

3. The method according to claim 1, wherein the exposed surface region of the substrate extends across a portion of the substrate surface which is wider than the predetermined pattern.

4. The method according to claim 1, wherein the second wavelength band is a near infrared, NIR, band, a medium infrared, MIR, band or an ultraviolet, UV, band.

5. The method according to claim 1, the method further comprising:
depositing an image forming fluid on the substrate during a same printing pass in which also the heating fluid is deposited.

6. The method according to claim 5, wherein the predetermined pattern in which the heating fluid is deposited extends along a line aligned to an image formed by depositing the image forming fluid.

7. The method according to claim 5, wherein the image forming fluid has a third maximum of radiation absorption at a third wavelength band, wherein the third wavelength band differs from the second wavelength band.

8. The method according to claim 1, wherein depositing the heating fluid and exposing the substrate to electromagnetic radiation are performed successively.

9. A device comprising:
a printing part including a first printhead to print, on a substrate, an image forming fluid having a first radiation absorption pattern over a wavelength and a second printhead to print, on a substrate, a heating fluid having a second radiation absorption pattern over a wavelength, wherein the first radiation absorption pattern is different from the second radiation absorption pattern;
a radiation part to expose at least a portion of the substrate to electromagnetic radiation having a wavelength band matching with a maximum of the second radiation absorption pattern to cut or mark the substrate along a pattern printed by the second printhead, wherein the radiation part is to expose a portion of the substrate that is wider than a shape to be printed by the second printhead.

10. The device according to claim 9, wherein the radiation part includes an infrared, IR, or ultraviolet, UV, emitter.

11. The device according to claim 9, wherein the radiation part includes a radiation emitter extending across a width of a print zone.

12. The device according to claim 11, wherein the radiation emitter is to simultaneously emit electromagnetic radiation across the entire width of the print zone.

13. The device according to claim 9, further including a printhead carriage wherein the first printhead and the second printhead both are arranged on the printhead carriage and are controlled to deposit the image forming fluid and the heating fluid during a same pass of the printhead carriage.

14. The device according to claim 13, wherein the radiation part is arranged on the printhead carriage.

15. A dye sublimation printer including
a printing part including a first printhead to print, on a substrate, an dye sublimation ink having a first radiation absorption pattern over a wavelength and a second printhead to print, on a substrate, a heating fluid having a second radiation absorption pattern over a wavelength, wherein the first radiation absorption pattern is different from the second radiation absorption pattern;
an adjustable radiation part to expose at least a portion of the substrate to electromagnetic radiation selectively at a first wavelength band matching with a maximum of the first radiation absorption pattern to sublimate the ink in an image area printed by the first printhead, and at a second wavelength band matching with a maximum of the second radiation absorption pattern to cut or mark the substrate along a pattern printed by the second printhead, wherein the radiation part is to expose a portion of the substrate that is at least as wide as the image area to be printed by the first printhead.
